(19) United States
(12) Patent Application Publication
(10) Pub. No.: US 2011/0010394 A1
(43) Pub. Date: Jan. 13, 2011

(54) CLIENT-SPECIFIC DATA CUSTOMIZATION FOR SHARED DATABASES

(75) Inventors: David J. Carew, Austin, TX (US); Ying C. Guo, Beijing (CN); Indrajit Poddar, Sewickley, PA (US); Mary E. Taylor, New Fairfield, CT (US)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 12/499,155

(22) Filed: Jul. 8, 2009

(51) Int. Cl. G06F 17/30

(52) U.S. Cl. 707/793; 707/E17.005; 707/E17.014; 707/E17.045

(57) ABSTRACT

A client identifier (ID) and a client-specific data field identifier for each item of client-specific data associated with a first client of a set of clients are received at a processor associated with a software as a service (SaaS) module. An extensible markup language (XML) formatted document for storing the client-specific data, including a set of client-specific data elements, each element referenced by one of the client-specific data field identifiers, is created for the first client. The XML formatted document is inserted into an XML formatted column of a row in a database table, where the database table is shared among a set of clients and stored in a shared database. The client ID is inserted into a structured query language (SQL) formatted data column of the row in the database table.

### BACKGROUND

The present invention relates to database storage reduction for shared databases. More particularly, the present invention relates to client-specific data customization for shared databases.

Software as a service (SaaS) represents a service-based approach to development, distribution, and support of software. SaaS applications are typically offered to clients (tenants) via a subscription. Client data is kept secure and isolated by partitioning the data and storing the data either via separate databases or via shared databases for SaaS applications. For shared databases, pre-allocated generic data fields are often generated for storing client-specific information. As applications are customized for different clients, the pre-allocated generic data fields are assigned to client-specific data fields differently and in different amounts based upon specific data storage needs for the different clients. Type checking is performed at the application level for data entered for storage into the pre-allocated generic data fields. Alternatively, extension tables are created to store client-specific data and these tables operated upon in conjunction with common application data using join operations. Metadata may be stored separately and operated upon using a separate join operation.

### SUMMARY

A method includes receiving, at a software as a processor associated with a service (SaaS) module, a client identifier (ID) and a client-specific data field identifier for each item of client-specific data associated with a first client of a plurality of clients; creating, for the first client, an extensible markup language (XML) formatted document for storing the client-specific data comprising a plurality of client-specific data elements, each element referenced by one of the client-specific data field identifiers; inserting the XML formatted document into an XML formatted column of a row in a database table, where the database table is shared among a plurality of clients and stored in a shared database; and inserting the client ID into a structured query language (SQL) formatted data column of the row in the database table.

A system includes a database shared among a plurality of clients; and a processor programmed to: receive a client identifier (ID) and a client-specific data field identifier for each item of client-specific data associated with a first client of the plurality of clients; create, for the first client, an extensible markup language (XML) formatted document for storing the client-specific data comprising a plurality of client-specific data elements, each element referenced by one of the client-specific data field identifiers; insert the XML formatted document into an XML formatted column of a row in a database table, where the database table is shared among a plurality of clients and stored in a shared database; and insert the client ID into a structured query language (SQL) formatted data column of the row in the database table.

A computer program product includes a computer readable storage medium including a computer readable program, where the computer readable program when executed on a computer causes the computer to receive, at a processor associated with a software as a service (SaaS) module, a client identifier (ID) and a client-specific data field identifier for each item of client-specific data associated with a first client of a plurality of clients; create, for the first client, an extensible markup language (XML) formatted document for storing the client-specific data comprising a plurality of client-specific data elements, each element referenced by one of the client-specific data field identifiers; insert the XML formatted document into an XML formatted column of a row in a database table, where the database table is shared among a plurality of clients and stored in a shared database; and insert the client ID into a structured query language (SQL) formatted data column of the row in the database table.

### BRIEF DESCRIPTION OF THE SEVERAL VIEWS OF THE DRAWINGS

Figure (FIG.) 1 is a block diagram of an example of an implementation of a system for client-specific data customization for shared databases according to an embodiment of the present subject matter;

Figure (FIG.) 2 is a block diagram of an example of an implementation of a software as a service (SaaS) device that provides client-specific data customization for shared databases according to an embodiment of the present subject matter;

Figure (FIG.) 3 is a flow chart of an example of an implementation of a process for automated client-specific data customization for shared databases according to an embodiment of the present subject matter;

Figure (FIG.) 4 is a flow chart of an example of an implementation of a process for configuring client-specific data customization for shared databases according to an embodiment of the present subject matter; and

Figure (FIG.) 5 is a flow chart of an example of an implementation of a process for client-specific data rendering and data change verification operations associated with client-specific data customization for shared databases according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides client-specific data customization for shared databases. The client-specific data customization for shared databases utilizes database layer functionality without requiring application updates to reduce data storage requirements for client-specific data within shared databases. Storage requirements are reduced by defining a unique extensible markup language (XML) column for storage of client-specific data for each client. Each XML column is stored hierarchically and is separately indexable along with general application columns formatted in structured query language (SQL). Space is only consumed within the shared database as required by the XML columns defined for the client-specific data. Storage of all client-specific data for each client in one XML column also improves client indexing within the shared database.

To retrieve data for a client from the shared database, a single query request, such as an xQuery request, may be used to retrieve both SQL and XML data. User interface modification for client-specific data fields may be customized via metadata interpreted at runtime rather than requiring software changes, and may be implemented using either dynamic profiles or object definitions. All metadata is keyed by a unique client identifier (e.g., client ID). It is understood that the term “tenant” may be used interchangeably with “client” in the context of SaaS applications and systems, and that the term “client” is used generally herein for ease of description purposes. Automated user interface customization is triggered by the client ID metadata field. Multi-tenancy in the SaaS environment refers to an ability to support multiple client organizations using shared computational resources (e.g., data center, physical servers, operating systems, databases, etc.). As such, the present subject matter applies at least equally to single-tenant and multi-tenant SaaS applications.

Data entry validation may be automatically performed by XML schema validation, such as validation of data for each element added to an XML column, using metadata. Data entry validation may also be automatically performed by a class object definition or other object relational mapping tool approach. Introspection may be performed at runtime to determine what data fields are present within the client-specific XML column. Display and user interface customization may be performed based upon the introspection results.

An example implementation platform for the XML columns includes IBM's pureXML® of DB2®, version 9. User interface objects may be implemented using javaServer® faces (JSF) objects. Additionally, the object relational mapping tool or class object definition approach may be implemented via Apache Software Foundation XMLBeans, or other service data objects (SDOs). It is understood that a person of skill in the art will be able to implement the present subject matter in association with these platforms based upon the description herein. Accordingly, specific details of each system are not provided herein for ease of illustration purposes.

The present subject matter also provides run-time update capabilities for changing client-specific data definitions within shared databases. For example, an XML document that defines client-specific data may be retrieved from a shared database, updated to add a new client-specific data field or to remove a defined client-specific data field, and stored back into the shared database during run time for an application. Application updates may be performed to introduce new business logic for utilization a new client-specific data field or to remove business logic that utilizes a removed client-specific data field, though it is understood that these application updates may be added during non-run time.

The client-specific data customization for shared databases described herein may be performed in real time to allow prompt creation, querying, and updating of client-specific data in association with shared databases. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

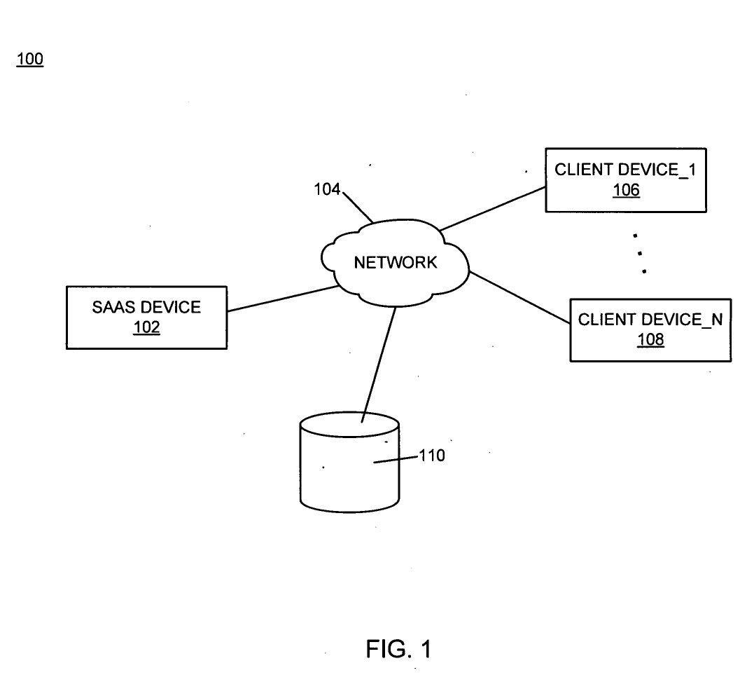

FIG. 1 is a block diagram of an example of an implementation of a system 100 for client-specific data customization for shared databases. Within the system 100, a software as a system (SaaS) device 102 is shown interconnected via a network 104 to a client device_1 106 through a client device_N 108. The SaaS device 102 provides client-specific data customization for the client device_1 106 through the client device_N 108 within a shared database 110.

The client device_1 106 through the client device_N 108 each represent a client computing system that utilizes a SaaS application generated via the SaaS device 102. The shared database 110 will be described in more detail below. The network 104 may include any form of interconnection suitable for the intended purpose, including a private or public network such as an intranet or the Internet, respectively, direct inter-module interconnection, dial-up, wireless, or any other interconnection mechanism capable of interconnecting the devices within the system 100.

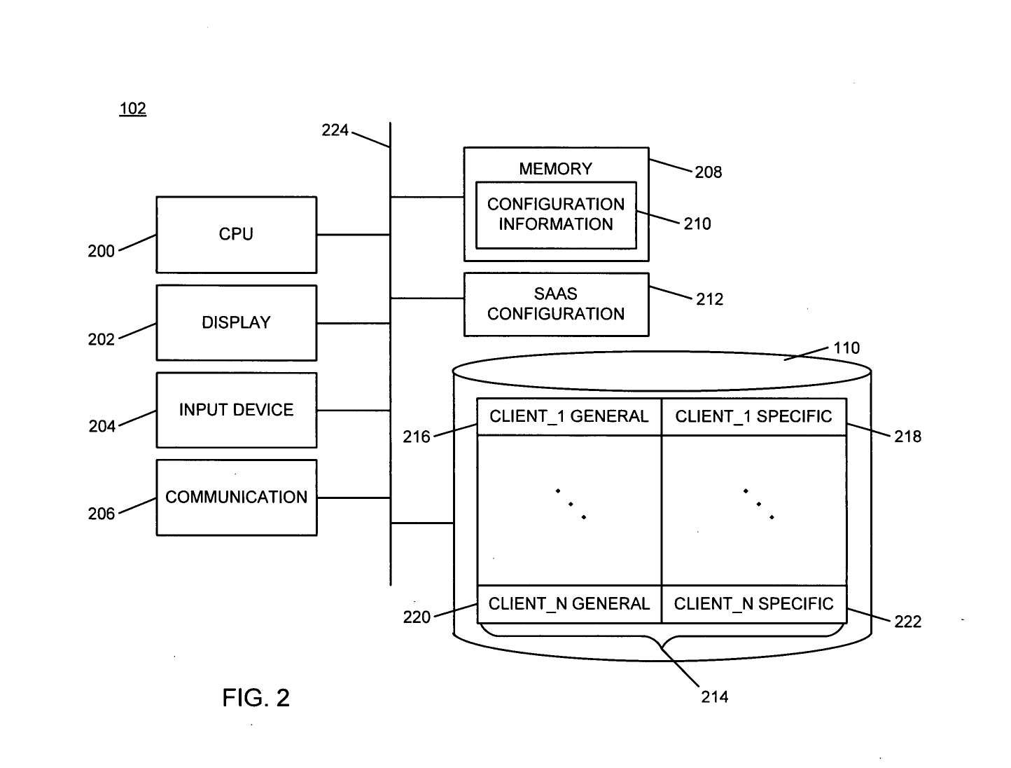

As will be described in more detail below in association with FIG. 2 through FIG. 5 and the pseudo code examples below, the SaaS device 102 provides client-specific data customization for shared databases within a system, such as the system 100. The client-specific data customization for shared databases is based upon use of a client-specific XML column in association with general application columns generated via SQL.

It should be noted that the SaaS device 102 may be a portable computing device, either by a user's ability to move the SaaS device 102 to different locations, or by the SaaS device 102's association with a portable platform, such as a plane, train, automobile, or other moving vehicle. It should also be noted that the SaaS device 102 may be any computing device capable of processing information as described above and in more detail below. For example, the SaaS device 102 may include devices such as a personal computer (e.g., desktop, laptop, palm, etc.) or a handheld device (e.g., cellular telephone, personal digital assistant (PDA), email device, music recording or playback device, etc.), or any other device capable of processing information as described in more detail below.

FIG. 2 is a block diagram of an example of an implementation of the SaaS device 102 that provides client-specific data customization for shared databases. A central processing unit (CPU) 200 provides computer instruction execution, computation, and other capabilities within the SaaS device 102. A display 202 provides visual information to a user of the SaaS device 102 and an input device 204 provides input capabilities for the user.

The display 202 may include any display device, such as a cathode ray tube (CRT), liquid crystal display (LCD), light emitting diode (LED), projection, touchscreen, or other display element or panel. The input device 204 may include a computer keyboard, a keypad, a mouse, a pen, a joystick, or any other type of input device by which the user may interact with and respond to information on the display 202.

A communication module 206 provides interconnection capabilities that allow the SaaS device 102 to communicate with other modules within the system 100, such as the client device_1 106 through the client device_N 108 and the shared database 110 to configure client-specific data customization for shared databases. The communication module 206 may include any electrical, protocol, and protocol conversion capabilities useable to provide the interconnection capabilities. Though the communication module 206 is illustrated as a component-level module for ease of illustration and description purposes, it should be noted that the communication module 206 may include any hardware, programmed processor(s), and memory used to carry out the functions of the communication module 206 as described above and in more detail below. For example, the communication module 206 may include additional controller circuitry in the form of application specific integrated circuits (ASICs), processors, antennas, and/or discrete integrated circuits and components for performing communication and electrical control activities associated with the communication module 206. Additionally, the communication module 206 may include interrupt-level, stack-level, and application-level modules as appropriate. Furthermore, the communication module 206 may include any memory components used for storage, execution, and data processing for performing processing activities associated with the communication module 206. The communication module 206 may also form a portion of other circuitry described without departure from the scope of the present subject matter.

A memory 208 includes a configuration information storage area 210 that stores information associated with client-specific data customization for shared databases. The stored configuration information may include general database configuration information for the shared database 110, client identifiers (IDs) for each of the client device_1 106 through the client device_N 108, client-specific data field identifiers, and other configuration information useable to configure client-specific XML columns for each of the client device_1 106 through the client device_N 108. The configuration information may be stored in the form of metadata and the metadata may be used to configure the XML columns for each client. The configuration information storage area 210 also stores completed SaaS applications for each of the client device_1 106 through the client device_N 108. These completed SaaS applications may be stored and executed from the memory 208 or may be communicated via the communication module 206 to the respective client device for execution.

It is understood that the memory 208 may include any combination of volatile and non-volatile memory suitable for the intended purpose, distributed or localized as appropriate, and may include other memory segments not illustrated within the present example for ease of illustration purposes. For example, the memory 208 may include a code storage area, a code execution area, and a data area without departure from the scope of the present subject matter.

The SaaS device 102 also includes a SaaS configuration module 212. The SaaS configuration module 212 implements the client-specific data customization for shared databases for the SaaS device 102. The SaaS configuration module 212 receives client-specific data requirements, such as from a user via the input device 204 and configures a client-specific XML data column for storage of the client-specific data. The SaaS configuration module 212 also combines the defined XML column with one or more general application columns to form a comprehensive definition of required data storage for a SaaS application for each respective client. The SaaS configuration module 212 allocates the appropriate storage for the client-specific XML data column and the general application column(s) within the shared database 110, as described in more detail below.

Though the SaaS configuration module 212 is illustrated as a component-level module for ease of illustration and description purposes, it should be noted that the SaaS configuration module 212 may include any hardware, programmed processor(s), and memory used to carry out the functions of this module as described above and in more detail below. For example, the SaaS configuration module 212 may include additional controller circuitry in the form of application specific integrated circuits (ASICs), processors, and/or discrete integrated circuits and components for performing communication and electrical control activities associated with the respective devices. Additionally, the SaaS configuration module 212 may include interrupt-level, stack-level, and application-level modules as appropriate. Furthermore, the SaaS configuration module 212 may include any memory components used for storage, execution, and data processing for performing processing activities associated with the SaaS configuration module 212.

It should also be noted that the SaaS configuration module 212 may form a portion of other circuitry described without departure from the scope of the present subject matter. Further, the SaaS configuration module 212 may alternatively be implemented as an application stored within the memory 208. In such an implementation, the SaaS configuration module 212 may include instructions executed by the CPU 200 for performing the functionality described herein. The CPU 200 may execute these instructions to provide the processing capabilities described above and in more detail below for the SaaS device 102. The SaaS configuration module 212 may form a portion of an interrupt service routine (ISR), a portion of an operating system, a portion of a browser application, or a portion of a separate application without departure from the scope of the present subject matter.

The shared database 110 is shown in association with the SaaS server 102 within FIG. 2 for ease of illustration purposes. However, it is understood that the shared database 110 may be interfaced with the SaaS device 102 via the communication module 206 and the network 104, as shown above in FIG. 1. The shared database 110 provides storage capabilities for information associated with the client-specific data customization for each of client device_1 106 through the client device_N 108. The shared database 110 includes multiple identified storage areas that may be stored in the form of tables or other arrangements accessible by the SaaS device 102 and/or the client device_1 106 through the client device_N 108.

For purposes of the present example, the shared database 110 is shown to include a table 214 shared among a set of clients, specifically the client device_1 106 through the client device_N 108, and stored in a shared database 110. Allocations for the client device_1 106 include a client_1 general storage area 216 which provides storage in any suitable format, such as SQL, for general information including a client ID associated with a client device_1 106 and/or any other appropriate information for a given implementation for general application use by a configured SaaS application. A client_1 specific storage area 218 is stored in the same row of the table 214 as the client_1 general storage area 216. The client_1 specific storage area 218 stores an XML formatted document, as described above and in more detail below, for storage of client-specific data for the client device_1 106.

The shared database 110 also includes similar configurations for each client device. As such, a client_N general storage area 220 and a client_N specific data storage area 222 are shown to illustrate that the shared database 110 includes a representative storage area as a row for each of these multiple client devices. It is understood that the description above for the storage allocations for the client device_1 106 applies to the storage areas allocation for each such client device.

The CPU 200, the display 202, the input device 204, the communication module 206, the memory 208, the SaaS configuration module 212, and the shared database 110 are interconnected via an interconnection 224. The interconnection 224 may include a system bus, a network, or any other interconnection capable of providing the respective components with suitable interconnection for the respective purpose.

While the SaaS device 102 is illustrated with and has certain components described, other modules and components may be associated with the SaaS device 102 without departure from the scope of the present subject matter. Additionally, it should be noted that, while the SaaS device 102 is described as a single device for ease of illustration purposes, the components within the SaaS device 102 may be co-located or distributed and interconnected via a network without departure from the scope of the present subject matter. For a distributed arrangement, the display 202 and the input device 204 may be located at a point of sale device, kiosk, or other location, while the CPU 200 and memory 208 may be located at a local or remote server. Many other possible arrangements for components of the SaaS device 102 are possible and all are considered within the scope of the present subject matter. It should also be understood that, though the client_1 general storage area 216, the client_1 specific storage area 218, through the client_N general storage area 220 and the client_N specific storage area 222 are shown within the single table 214 in the shared database 110, they may also be stored within multiple tables within the shared database 110 or may be stored within the memory 208 without departure from the scope of the present subject matter. Accordingly, the SaaS device 102 may take many forms and may be associated with many platforms.

Several pseudo code examples of client-specific data customization for shared databases are provided and described below. It is understood that the following pseudo code examples are provided to facilitate understanding of the present subject matter. Many other variations on the pseudo code examples are possible and all such variations are considered within the scope of the present subject matter.

The first pseudo code example provides one possible configuration for a general definition of a database table for use within a shared database for banking clients to provide client-specific data customization for shared databases. Each client bank may have a SaaS configuration table created within a shared database, such as the shared database 110, based upon the following example definition. Within the following pseudo code example definition, each referenced identifier and associated data type defines a column of data with a table created based upon this definition.

| SAASBNK.ACCOUNTXML | |
|---|---|
| (BANKID | VARCHAR(10), |
| ACCID | INTEGER, |
| ACCTNAME | VARCHAR(25), |
| DESCR | VARCHAR(75), |
| BALANCE | DEC(15,2), |
| ACCTYPE | CHAR(3), |
| CUSTID | INTEGER, |
| ACCOUNTDATA | XML); |

As can be seen from the preceding pseudo code example, several columns of data are defined. The majority of these column definitions define general columns that may be created in any suitable framework, such as SQL, to define storage locations for general SaaS application data columns. The amount of storage allocated for these general columns will be constant for each client based upon the present subject matter. These columns are not described in further detail as a person of skill in the art will be able to construct a suitable table definition for a given SaaS application based upon the present description of the client-specific data customization for shared databases.

The last column within the pseudo code example is defined as a column of type XML that is formatted as an XML data column and that is named “ACCOUNTDATA.” The XML formatted column is used to store XML documents including client-specific information. The amount of storage allocated for this column may vary for each client depending upon the particular (e.g., specific) data storage needs for each respective client. When a new client is to have storage configured within the shared database 110, a new XML document may be created and inserted into a row in a database table that is shared among a set of clients and stored in the shared database 110, for storage of information for that client. The XML formatted data document may be defined separately for each new client added to the shared database 110.

The following second pseudo code example of an XML schema definition (XSD) for an XML formatted document for a bank called “Local Bank” illustrates one possible format for a client-specific XML formatted data column and a schema for column data verification. It should be noted that the name of this XSD is “AccountData,” as referenced above as the XML formatted document in the first pseudo code example.

### Local Bank's AccountData XSD:

```
<xsd:complexType name=“AccountData”>
    <xsd:account>
        <xsd:element name=“acctOpen” nillable=“false”
        type=“xsd:date” />
        <xsd:element name=“acctStatus” nillable=“false”
        type=“xsd:string” />
    </xsd:account>
</xsd:complexType>
```

As can be seen from this second pseudo code example, Local Bank has two rows of client-specific data defined within its XML column via the XML schema definition. The first data element is an account opening date element (e.g., acctOpen) of type “date.” The second data element is an account status element (e.g., acctStatus) of type “string.”

The following third pseudo code example of an XSD for an XML formatted document for a bank called “Web Bank” illustrates one possible format for a client-specific XML formatted data column and a schema for column data verification for a second client bank.

### Web Bank's AccountData XSD:

```
<xsd:complexType name=“AccountData”>
    <xsd:account>
        <xsd:element name=“dateOpened” nillable=“false”
        type=‘xsd:date”/>
    </xsd:account>
</xsd:complexType>
```

As can be seen from this third pseudo code example, Web Bank has only one XML data element of client-specific data defined within its XML column via the XML schema definition. This element is also an account opening date element (e.g., dateOpened) of type “date.” However, it should be noted that the name of this element of data “dateOpened” is different from that of Local Bank named “acctOpen,” as described above. As such, clients may have customized names for client-specific data fields. It should also be noted that the shared database 110 does not need to allocate storage for a second data element that is not requested by Web Bank, such as for the second data element defined for Local Bank described above and titled “acctStatus.”

Accordingly, based upon the present examples, client-specific data may be customized for each client within a shared database based upon the individual data storage needs of each respective client. Data field names for each client may be customized. In addition, storage may be allocated for the fields defined for each client and unused storage for any given client is not allocated. It is further noted that clients are not burdened by having to change data field names from default names for pre-allocated fields and are not required to have a user interface that includes unused pre-allocated fields.

It should further be noted that XML column template definitions may also be created that provide common XML formatted element names for data that is to be allocated for each client. For example, if each client is to be allowed to request a unique account name, an account name field (e.g., acctName) may be created within the XML column template definition to allow the client to control entry of the account name. Additional element definitions may be added, as described above, for each client to reference each client's unique data storage needs. Additionally, new element definitions may be added during run time without terminating execution of a particular SaaS application. For example, the XML formatted column may be retrieved from the shared database 110, a new client-specific data element may be added to the XML formatted document during run-time, and the XML formatted document with the new client-specific data element may be inserted into an XML formatted column of the row in the database table. The new client-specific data element may be utilized during application-level processing by adding application-level functionality to utilize the new client-specific data element, though it is understood that these application updates may be added during non-run time.

Regarding display of client-specific data, user interface components may be configured dynamically in a client-specific format during a rendering operation based upon the XSD defined for each respective client. Element names within the XML document definition may be used/stored as metadata. This metadata may be parsed in real-time during rendering operations to dynamically configure user interface components to display the client-specific data. Example approaches to dynamic creation of client-specific user interface components include the use of dynamic profiles. IBM's® Websphere® Portlet Factory provides one example of an interface suitable for user interface rendering based upon the present subject matter. Another example includes using javaServer® faces (JSF) objects.

Within either example user interface environment, metadata such as element name information associated with XML columns may be used to determine field names and to identify data field contents for user interface entity rendering. Regardless of the chosen user interface environment, the SaaS application itself does not need to be changed to accommodate customized user interface deployment based upon the present subject matter. It is understood that a person of skill in the art will be able to implement the present subject matter using either IBM's® Websphere® Portlet Factory or javaServer® faces (JSF) objects, or within other platforms, based upon the present description. Accordingly, additional description is not provided herein for brevity.

Regarding application coding for SaaS applications in the context of the present subject matter, several options exist for coding of SaaS applications as well. One example is to use XSD validation during rendering and for validation during user input changes to data associated with XML columns that include client-specific data. Another option is to use class definitions for data validation, such as Apache Software Foundation XMLBeans. Using XML Beans, Java® types may be created from the XML itself. Because data is stored in an XML format, objects may be created at run time. Introspection of created classes may be performed for validation during user input changes to data associated with XML columns that include client-specific data. It is understood that a person of skill in the art will be able to implement the present subject matter using either XSD validation or Apache Software Foundation XMLBeans, or within other platforms, based upon the present description. Accordingly, additional description is not provided herein for brevity. These and other service data objects (SDOs) may work with changes to the data layer and to implement business logic and transactional application code may remain unaffected.

As described above, data storage customization, user interface customization, and client-specific data validation may be provided in association with the present subject matter based upon metadata that defines the data elements for the XML columns that store client-specific data. Data storage customization, user interface customization, and client-specific data validation for shared databases may be implemented without changes to application code of the respective SaaS application for each client. Additionally, user interface customization and client-specific data validation may be performed in real time during SaaS application execution based upon metadata, either at the database level or the application level, without additional validation code generation requirements.

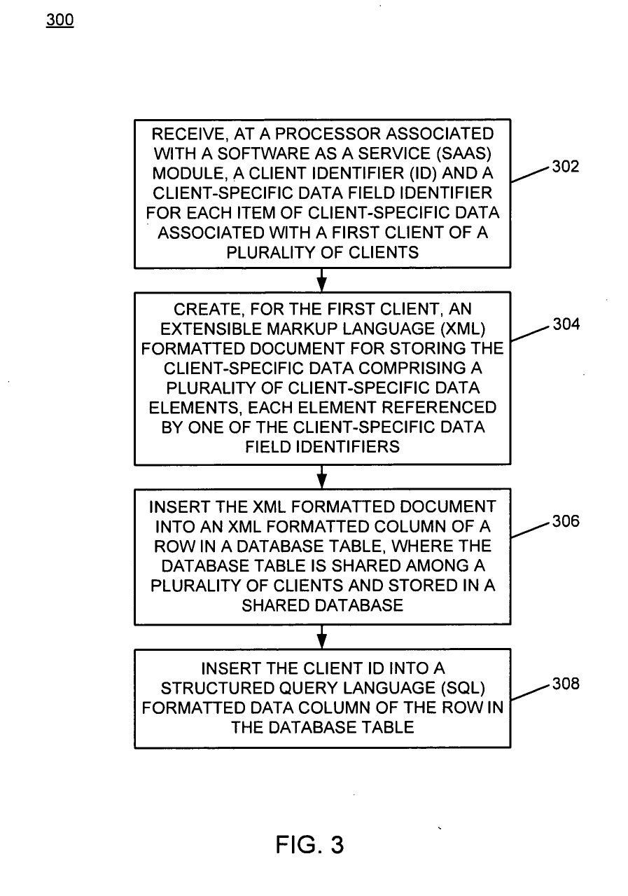

FIG. 3 through FIG. 5 below describe example processes that may be executed by devices, such as the SaaS device 102, to perform the client-specific data customization for shared databases associated with the present subject matter. Many other variations on the example processes are possible and all are considered within the scope of the present subject matter. The example processes may be performed by modules, such as the SaaS configuration module 212 and/or executed by the CPU 200, associated with such devices. It should be noted that time out procedures and other error control procedures are not illustrated within the example processes described below for ease of illustration purposes. However, it is understood that all such procedures are considered to be within the scope of the present subject matter.

FIG. 3 is a flow chart of an example of an implementation of a process 300 for automated client-specific data customization for shared databases. At block 302, the process 300 receives, at a software as a service (SaaS) module, a client identifier (ID) and a client-specific data field identifier for each item of client-specific data associated with a first client of a plurality of clients. At block 304, the process 300 creates, for the first client, an extensible markup language (XML) formatted document for storing the client-specific data comprising a plurality of client-specific data elements, each element referenced by one of the client-specific data field identifiers. At block 306, the process 300 inserts the XML formatted document into an XML formatted column of a row in a database table, where the database table is shared among a plurality of clients and stored in a shared database. At block 308, the process 300 inserts the client ID into a structured query language (SQL) formatted data column of the row in the database table.

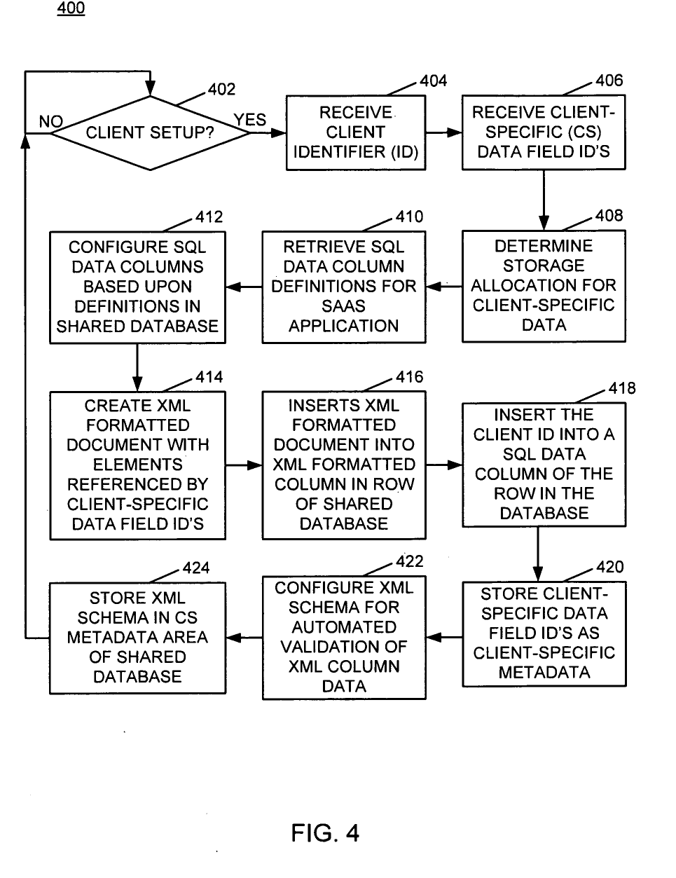

FIG. 4 is a flow chart of an example of an implementation of a process 400 for configuring client-specific data customization for shared databases. At decision point 402, the process 400 waits for an indication to set up a new client within a shared database, such as the shared database 110. When a determination is made that a request to set up a new client has been received, the process 400 receives a client identifier (ID) associated with the client at block 404. Receipt of the client ID or any other information may be automated as part of an automated configuration for a new client or may be received from a user via the input device 204.

At block 406, the process 400 receives client-specific (CS) data field identifiers (IDs). Receipt of the client-specific data field IDs may also be automated as part of an automated configuration for a new client or may be received from a user via the input device 204, and may include any data type information associated with the client-specific data field IDs. At block 408, the process 400 determines a storage allocation for the client-specific data. The storage allocation may be based upon the data formatting, field types, and other characteristics of the client-specific data, and may also be based upon available data field partitioning or other characteristics associated with the shared database 110.

At block 410, the process 400 retrieves SQL data column definitions for the SaaS application to be configured. The SQL data column definitions represent the common or general SQL columns associated with the SaaS application. At block 412, the process 400 configures SQL data columns within the shared database 110 based upon the received SQL data column definitions.

At block 414, the process 400 creates an XML formatted data document with elements referenced by the client-specific data field IDs. At block 416, the process 400 inserts the XML formatted client-specific data document into an XML formatted column of a row in a database table, where the database table is shared among a plurality of clients and stored in the shared database 110. The XML formatted client-specific data document may be stored, for example, within the client_1 specific data storage area 218. At block 418, the process 400 inserts the client ID into a structured query language (SQL) formatted data column of the row in the database table.

At block 420, the process 400 stores the client-specific data field IDs as client-specific metadata. The client-specific metadata may be stored, for example, as client-specific data field identifiers associated with each element of an XML formatted document stored within a data area such as the client_1 specific storage area 218. Storing of the client-specific data field IDs as client-specific metadata includes storing the client-specific data field IDs for each item of client-specific data associated with the client as client-specific metadata, each representing one of the rows of the XML formatted document.

At block 422, the process 400 configures an XML schema for automated validation of data entered into the XML formatted document configured for the client based upon a data type associated with each item of client-specific data. At block 424, the process 400 stores the XML schema in association with the XML formatted document in the shared database 100.

As such, the process 400 configures client-specific data customization for shared databases. Client-specific data fields are received and each item of client-specific data is used as metadata to reference a configured element of an XML formatted document of client-specific data. An XML schema is configured to validate entry of data into the XML formatted document. Data storage is improved and allocated based upon a data type associated with each item of client-specific data without allocation of additional unused storage.

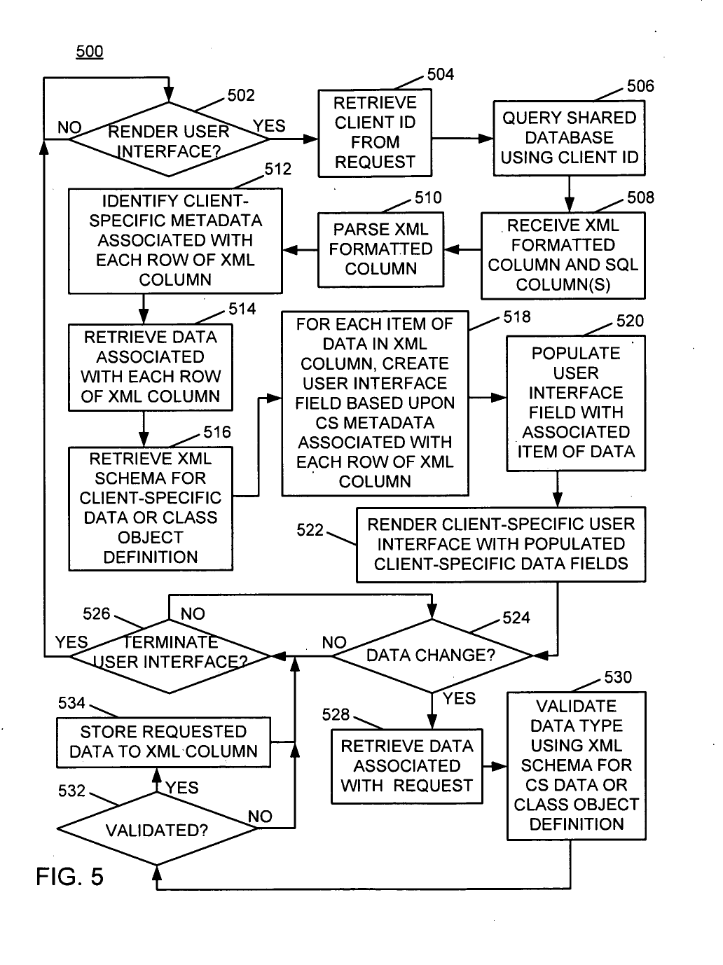

FIG. 5 is a flow chart of an example of an implementation of a process 500 for client-specific data rendering and data change verification operations associated with client-specific data customization for shared databases. At decision point 502, the process 500 waits to receive a request to render a user interface for a client. As described above, rendering the user interface may include rendering of client-specific data. For purposes of the present example, it is assumed that a client ID is received with a request. However, other forms of associating a request with a particular client, such as use of a client name with reference to stored metadata associated with each client, are possible and all are considered within the scope of the present subject matter. Additionally, as described above, the client-specific data is stored within an XML formatted document and indexed on an element or attribute in the document. Metadata is stored and used to identify the items of client-specific data within the XML formatted document and an XML schema may be used to validate data entry into the XML formatted document.

When the process 500 makes a determination that a request to render a user interface for a client has been received, the process 500 retrieves a client ID from the request at block 504. At block 506, the process 500 performs a query operation of a shared database, such as the shared database 110, using the client ID. The query operation may further include an xQuery operation of the shared database using the client ID to retrieve both the XML formatted document and the general SQL application column(s).

At block 508, the process 500 receives data associated with the XML formatted document and SQL column(s) configured for the client from the shared database 110 in response to the query. At block 510, the process 500 parses the XML formatted document. At block 512, the process 500 identifies the client-specific metadata associated with each element of the XML formatted document. At block 514, the process 500 retrieves the data associated with each element of the XML formatted document using the client-specific metadata associated with each element of the XML formatted document.

At block 516, the process 500 retrieves the XML schema for the client-specific data or a class object definition that may be used for verification of any subsequent data changes to the client-specific data. At block 518, the process 500 begins the process of rendering a user interface by creating a user interface field for the client based upon the client-specific metadata, including each item of data associated with each element of the XML formatted document. At block 520, the process 500 populates each user interface field with the associated item of data from the XML formatted document. At block 522, the process 500 renders the client-specific user interface with the populated client-specific data fields. As such, a customized user interface element (e.g., a dialog box) is created based upon the client-specific metadata, and each data field of the customized user interface entity is populated with the respective data from the retrieved XML formatted document of client-specific data.

At decision point 524, the process 500 makes a determination as to whether a request to change any item of data within the client-specific user interface entity has been received. When a determination is made that no request to change any item of data within the client-specific user interface entity has been received, the process 500 makes a determination at decision point 526 as to whether a request to terminate rendering of the client-specific user interface has been received. The request to terminate rendering of the client-specific user interface may be received in association with a request to close the SaaS application or by other navigation requests received, for example, from the input device 204. When a determination is made that a request to terminate rendering of the client-specific user interface has not been received, the process 500 returns to decision point 524 to again make a determination as to whether a request to change any item of data within the client-specific user interface entity has been received.

When a determination is made at decision point 524 that a request to change any item of data within the client-specific user interface entity has been received, the process 500 retrieves the requested changed data from the received request and retrieves the previously populated data associated with the request from the XML formatted document or from the populated field of the client-specific user interface entity at block 528. At block 530, the process 500 validates the data change request using the client-specific metadata associated with the populated user interface field. This validation may include automatically validating a data type associated with the requested data via the configured XML schema based upon a data type associated with each item of client-specific data if an XML schema was retrieved at block 516. Alternatively, the validation may include automatically validating a data type associated with the requested data via a class object definition created based upon a data type associated with each item of client-specific data if a class object definition was retrieved at block 516.

At decision point 532, the process 500 makes a determination as to whether the data change has been validated based upon the XML schema or the class object definition. When a determination is made that the data change has been validated, the process 500 stores the requested data to the XML column upon automated validation of the requested data at block 534. The metadata associated with the XML column may be used to reference the appropriate storage location for the requested data. It should be noted that upon determining that the validation of the requested data failed at decision point 532, the process 500 may perform suitable processing and actions to prompt a user, such as via the display 202, to reenter the data. Additional processing to receive updated data for the change and other processing may also be performed. These additional processing steps are not shown for ease of illustration purposes.

Upon completion of operations to store the requested data to the XML column at block 534 or upon determining that the automated validation of the data failed at decision point 532, the process 500 returns to decision point 526 to continue iterating as described above. Upon determining that a request to terminate rendering of the client-specific user interface has been received, the process 500 returns to decision point 502 to await a new request to render a user interface for a client.

As such, the process 500 provides an example of processing for client-specific data rendering and data change verification operations associated with client-specific data customization for shared databases. The process 500 renders a client-specific user interface with data fields populated with data stored within an XML formatted client-specific data document stored in an XML formatted column of a row in a database table in association with general application information for the same client stored in the row in an SQL formatted data column in the database table. Each data change request is validated against either an XML schema or a class object definition created based upon a data type associated with each item of client-specific data.

As described above in association with FIG. 1 through FIG. 5, the example systems and processes provide client-specific data customization for shared databases. Many other variations and additional activities associated with client-specific data customization for shared databases are possible and all are considered within the scope of the present subject matter.

Those skilled in the art will recognize, upon consideration of the above teachings, that certain of the above examples are based upon use of a programmed processor such as the CPU 200. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
receiving, at a processor associated with a software as a service (SaaS) module, a client identifier (ID) and a client-specific data field identifier for each item of client-specific data associated with a first client of a plurality of clients;
creating, for the first client, an extensible markup language (XML) formatted document for storing the client-specific data comprising a plurality of client-specific data elements, each element referenced by one of the client-specific data field identifiers;
inserting the XML formatted document into an XML formatted column of a row in a database table, where the database table is shared among a plurality of clients and stored in a shared database; and
inserting the client ID into a structured query language (SQL) formatted data column of the row in the database table.

2. The method of claim 1, further comprising:
configuring an XML schema for automated validation of data entered into the XML formatted document created for the first client based upon a data type associated with each item of client-specific data; and
storing the XML schema in association with the XML formatted document in the shared database.

3. The method of claim 1, further comprising:
receiving a request via a user input device to render a user interface for the first client of the plurality of clients;
performing a query operation of the shared database using the client ID; and
receiving the XML formatted document created for the first client in response to the query.

4. The method of claim 3, further comprising:
parsing the XML formatted document;
identifying as client-specific metadata each client-specific data field identifier that references each of the plurality of client-specific data elements associated with the XML formatted document;
retrieving, from the shared database, data associated with each element of the XML formatted document using the client-specific metadata associated with each element of the XML formatted document; and
rendering the user interface for the first client on a display based upon the client-specific metadata associated with each element of the XML formatted document.

5. The method of claim 4, where rendering the user interface for the first client based upon the client-specific metadata comprises:
for each item of data associated with the XML formatted document:
creating a user interface field based upon the client-specific metadata associated with each element of the XML formatted document; and
populating the user interface field on the display with the associated item of data.

6. The method of claim 5, further comprising:
receiving a data change request and requested data via the user input device requesting a change to one of the populated items of data to the requested data;
automatically validating a data type associated with the requested data using at least one of a configured XML schema and a class object definition created based upon a data type associated with each item of client-specific data; and
storing the requested data to the XML column upon automated validation of the data type associated with the requested data.

7. The method of claim 1, further comprising:
retrieving the XML formatted document from the shared database;
adding a new client-specific data element to the XML formatted document during run-time;
inserting the XML formatted document with the new client-specific data element into the XML formatted column of the row in the database table; and
utilizing the new client-specific data element during application-level processing.

8. A system, comprising:
a database shared among a plurality of clients; and
a processor programmed to:
receive a client identifier (ID) and a client-specific data field identifier for each item of client-specific data associated with a first client of the plurality of clients;
create, for the first client, an extensible markup language (XML) formatted document for storing the client-specific data comprising a plurality of client-specific data elements, each element referenced by one of the client-specific data field identifiers;
insert the XML formatted document into an XML formatted column of a row in a database table, where the database table is shared among a plurality of clients and stored in a shared database; and
insert the client ID into a structured query language (SQL) formatted data column of the row in the database table.

9. The system of claim 8, where the processor is further programmed to:
configure an XML schema for automated validation of data entered into the XML formatted document created for the first client based upon a data type associated with each item of client-specific data; and
store the XML schema in association with the XML formatted document in the shared database.

10. The system of claim 8, further comprising:
a display device; and
where the processor is further programmed to:
receive a request to render a user interface for the first client of the plurality of clients on the display device;
perform a query operation of the shared database using the client ID; and
receive data associated with the XML formatted document created for the first client in response to the query.

11. The system of claim 10, where the processor is further programmed to:
parse the XML formatted document;
identify as client-specific metadata each client-specific data field identifier that references each of the plurality of client-specific data elements associated with the XML formatted document;
retrieve, from the shared database, data associated with each element of the XML formatted document using the client-specific metadata associated with each element of the XML formatted document; and
render the user interface for the first client on the display based upon the client-specific metadata associated with each element of the XML formatted document.

12. The system of claim 11, where, in being programmed to render, on the display, the user interface for the first client based upon the client-specific metadata, the processor is programmed to:
for each item of data associated with the XML formatted document:
create a user interface field based upon the client-specific metadata associated with each element of the XML formatted document; and
populate the user interface field with the associated item of data.

13. The system of claim 12, further comprising:
a user input device; and
where the processor is further programmed to:
receive a data change request and requested data via the user input device requesting a change to one of the populated items of data to the requested data;
automatically validate a data type associated with the requested data using at least one of a configured XML schema and a class object definition created based upon a data type associated with each item of client-specific data; and
store the requested data to the XML column in the shared database upon automated validation of the requested data.

14. A computer program product comprising a computer readable storage medium including a computer readable program, where the computer readable program when executed on a computer causes the computer to:
receive, at a processor associated with a software as a service (SaaS) module, a client identifier (ID) and a client-specific data field identifier for each item of client-specific data associated with a first client of a plurality of clients;
create, for the first client, an extensible markup language (XML) formatted document for storing the client-specific data comprising a plurality of client-specific data elements, each element referenced by one of the client-specific data field identifiers;
insert the XML formatted document into an XML formatted column of a row in a database table, where the database table is shared among a plurality of clients and stored in a shared database; and
insert the client ID into a structured query language (SQL) formatted data column of the row in the database table.

15. The computer program product of claim 14, where the computer readable program when executed on a computer further causes the computer to
configure an XML schema for automated validation of data entered into the XML formatted document created for the first client based upon a data type associated with each item of client-specific data; and
store the XML schema in association with the XML formatted document in the shared database.

16. The computer program product of claim 14, where the computer readable program when executed on the computer further causes the computer to:
receive a request via a user input device to render a user interface for the first client of the plurality of clients;
perform a query operation of the shared database using the client ID; and
receive data associated with the XML formatted document created for the first client in response to the query.

17. The computer program product of claim 16, where the computer readable program when executed on a computer further causes the computer to:
parse the XML formatted document;
identify as client-specific metadata each client-specific data field identifier that references each of the plurality of client-specific data elements associated with the XML formatted document;
retrieve, from the shared database, data associated with each element of the XML formatted document using the client-specific metadata associated with each element of the XML formatted document; and
render the user interface for the first client on the display based upon the client-specific metadata associated with each element of the XML formatted document.

18. The computer program product of claim 17, where, in causing the computer to render the user interface for the first client based upon the client-specific metadata, the computer readable program when executed on a computer further causes the computer to:
for each item of data associated with the XML formatted document:
create a user interface field based upon the client-specific metadata associated with each element of the XML formatted document; and
populate the user interface field on the display with the associated item of data.

19. The computer program product of claim 18, where the computer readable program when executed on the computer further causes the computer to:
receive a data change request and requested data via the user input device requesting a change to one of the populated items of data to the requested data;
automatically validate a data type associated with the requested data using at least one of a configured XML schema and a class object definition created based upon a data type associated with each item of client-specific data; and
store the requested data to the XML column upon automated validation of the data type associated with the requested data.

20. The computer program product of claim 18, where the computer readable program when executed on the computer further causes the computer to:
retrieve the XML formatted document from the shared database;
add a new client-specific data element to the XML formatted document during run-time;
insert the XML formatted document with the new client-specific data element into the XML formatted column of the row in the database table; and
utilize the new client-specific data element during application-level processing.
